(19) United States
(12) Patent Application Publication
(10) Pub. No.: US 2006/0262091 A1
(43) Pub. Date: Nov. 23, 2006

(54) Wireless mouse with a structure for collecting a wireless receiver

(76) Inventor: Hua-Wei Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/134,405

(22) Filed: May 23, 2005

(51) Int. Cl. G09G 5/08

(52) U.S. Cl. 345/163

(57) ABSTRACT

A wireless mouse provided with a structure for collecting a wireless receiver is made up with a base, a mouse body, a frame, and a top cover. A lift-suitable cover body is provided in a middle button of the wireless mouse, a storage case is provided below the cover body, inside which an accommodation groove is provided that is used to accommodate the wireless receiver of the wireless mouse. When the mouse is used, a push button on the base is pushed to have the hook come off the storage case so that the lift-suitable cover body are opened upward following the shaft with the tension of spring; next, the wireless receiver may be taken out and used; after it is taken out, the cover body may still be pushed down for normal operation of the wireless mouse with the aid of hook.

### BACKGROUND OF THE INVENTION

1. Field of the Invention

This invention relates to a wireless mouse provided with a structure for collecting a wireless receiver and particularly to that for collecting the wireless receiver for convenient reposit and carry.

2. Description of the Prior Art

A wireless mouse is a computer input device that is currently familiar and will be developed universally in the future. The wireless mouse has not been a standard I/O device of a computer, so a general computer is not provided with a function for controlling the wireless mouse, thereby a dedicated wireless receiver being required. Also, all the wireless mice provided all manufacturers are different in functions and features so that the general wireless must be sold with its wireless receiver; otherwise, the wireless mouse cannot work.

However, compared with a conventional mouse, the wireless mouse works with the wireless receiver extra. The receiver looks insignificant so that the user usually forgets to carry it or seriously loses it so as to make the wireless mouse not work. Thus, the wireless mouse is inconvenient to some users so that the conventional mouse is preferred.

In the market, some wireless mice are currently sold that is provided with a space for accommodating the wireless receiver for prevention of the defects described above. However, such a wireless mouse must be provided with the extra space and thereby the mouse becomes big in volume or is affected in features. Alternatively, the wireless mouse is used inconveniently so that the user is not willing to use it.

For this reason, this invention is to provide the wireless mouse with the structure for collecting the wireless receiver, using the existing space provided in the wireless mouse and selecting a measure of skilled combination in consideration of good appearance so that the wireless mouse may be easily used. Through a long-term development and experiment, the wireless mouse may be finally achieved.

### SUMMARY OF THE INVENTION

This invention is to provide a wireless mouse provided with a structure collecting a wireless receiver. A space beneath a third button of the wireless mouse is used as a light and handy collecting structure to accommodate the wireless receiver and the mouse of which appearance is considered is used conveniently.

This invention is to further provide that of simple structure, low cost, and hard body.

The wireless mouse reaching the object above is provided with a base inside which a mouse body is located that is masked with a frame outside which a top cover is provided. A lift-suitable cover body is provided in a middle button of the wireless mouse and a shaft is provided at a front end of the cover body so that the cover body may rotate around the shaft; a storage case is provided below the cover body, inside which an accommodation groove is provided that is used to accommodate the wireless receiver of the wireless mouse; a hook is provided below the storage case, a push button is provided beneath the hook, and a recovery spring is provided between the base and the hook in the direction of compression of the push button; a piercing spring is located on the storage case and an elastic center of the two ends of spring is fixed onto the frame; the ends are supported on the frame and a trigger button is provided at the rear of base. The mouse according to this invention ordinarily accommodates the wireless receiver in the groove so that the receiver is made to push down the trigger button to disable the wireless mouse; when the mouse is needed, a push button on the base is pushed to have the hook come off the storage case so that the storage case and the lift-suitable cover body are opened upward following the shaft with the tension of spring; next, the wireless receiver may be taken out and used; after it is taken out, the cover body may still be pushed down for normal operation of the wireless mouse with the aid of hook.

### BRIEF DESCRIPTION OF THE DRAWINGS

The drawings disclose an illustrative embodiment of the present invention which serves to exemplify the various advantages and objects hereof, and are as follows:

FIG. 1 is a 3D view of this invention.

FIG. 2 is an exploded view of this invention.

FIG. 3 is a top view of this invention of which a top cover is removed.

FIG. 4 is an upward view of this invention.

FIG. 5 is a detailed view of this invention.

FIG. 6 is a schematic view illustrating operation of a structure of this invention.

FIG. 7 is a schematic view illustrating the appearance of operation of this invention.

FIG. 8 is an illustration of variation of the structure of this invention.

### DETAILED DESCRIPTION OF THE PREFERRED EMBODIMENT

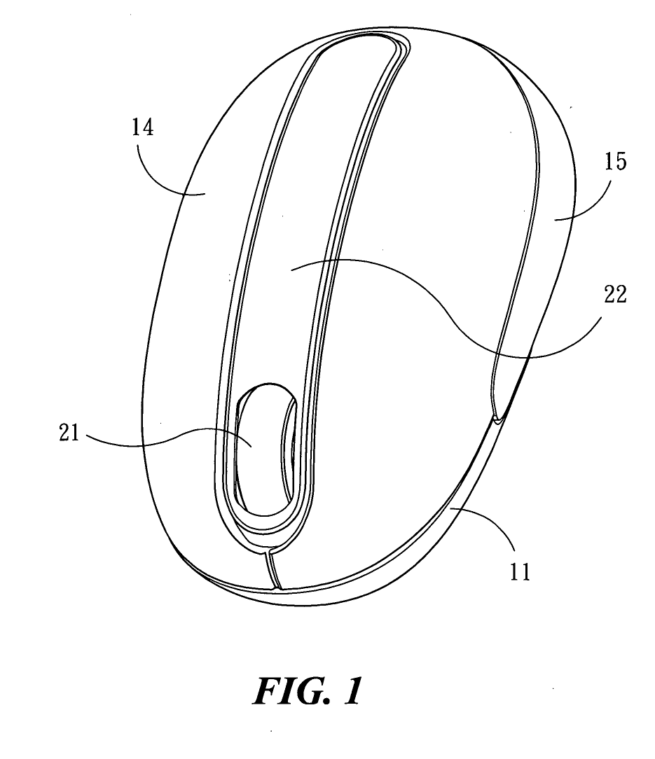

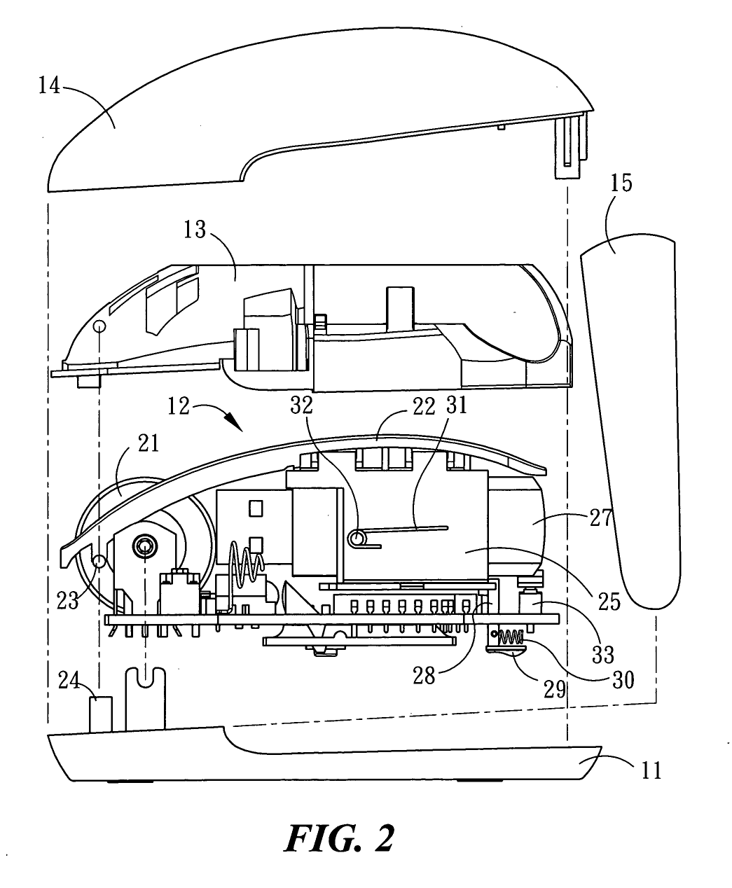

Referring now to FIGS. 1 and 2, this invention provides a wireless mouse provided with a structure for collecting a wireless receiver and the mouse is provided with a base 11 inside which a mouse body 12 is located that is masked with a frame 13 outside which a top cover 14 is provided, in which the base 11 and the top cover 14 are assembled as the appearance of wireless mouse body 12 comprising a controlling structure and a circuit that provide functions for operation of the wireless mouse, and the frame 13 serves to support the controlling structure of the mouse body 12. The base 14 is further inserted with an arc-shaped fringe 15 that is familiarly designed, so unnecessary details are not given here.

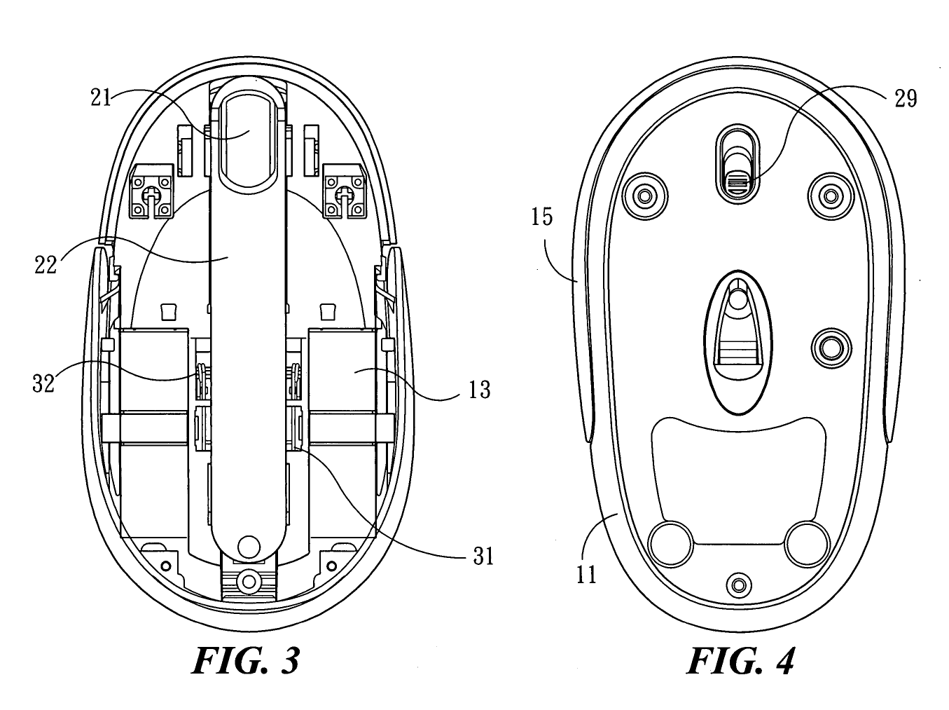

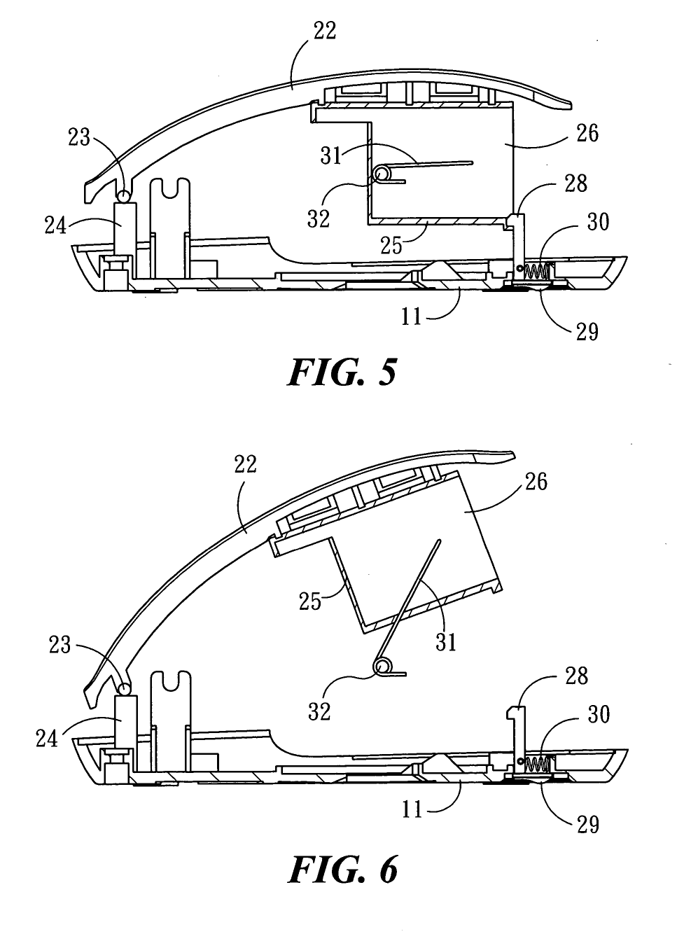

Referring now to FIGS. 3 to 5, with the structure mentioned above, this invention is characterized that a lift-suitable cover body 22 is provided in a middle button 21 of the wireless mouse and a shaft 23 is provided at a front end of the cover body 22, in which the shaft 23 is located on a pillar 24 stretching from the base 11 upward so that the cover body 22 may rotate around the shaft 23 of which an end goes deep into the frame 13, thereby the lift-suitable cover body 22 keeping the position of shaft when rotating. A storage case 25 is provided below the cover body 22, inside which an accommodation groove 26 is provided that is used to accommodate the wireless receiver 27 of the wireless mouse, and the storage case 25 is hooked below cover body 22 for removal or replacement of the storage case 25. A hook 28 is provided below the storage case 25, a push button 29 is provided on the base 11 beneath the hook 28, and a recovery spring 30 is provided between the base 11 and the hook 28 in the direction of compression of the push button 29 so that when the push button 29 is compressed, the hook 28 is made to come off the storage case 26 for rotation of the lift-suitable cover body. A piercing spring 31 is located on the storage case 25, an elastic center 32 of the two ends of spring 31 is fixed onto the frame 13, and the ends are also supported on the frame 13 so that the segment of spring 31 passing through the storage case 25 may elastically push the storage case 25 following the elastic center 32 as an axis. Further, a trigger button 33 is provided at the rear of base 11, and when the wireless receiver 27 inside the cover body 22 is pushed down, the receiver 27 may push down the trigger button 33 and then the power of the mouse is disconnected, thereby the mouse stopping work.

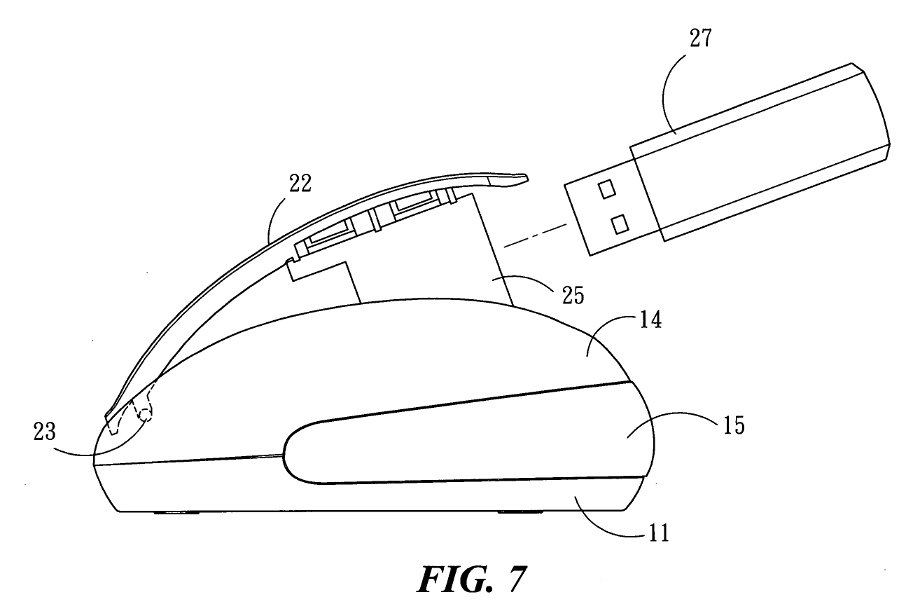

Referring now to FIGS. 6 and 7, when this invention is practically used, the wireless receiver 27 is ordinarily inserted into the groove 26 so that the receiver 27 is made to push down the trigger button 33 to disable the function of wireless mouse, and the receiver is hidden in the mouse for easy carry and storage. When the mouse is needed, the push button 29 on the base 11 is pushed to have the hook 28 come off the storage case 25 so that the storage case 25 is made with the tension of spring 31 to push upward and has the lift-suitable cover body 22 opened upward following the shaft 23; next, the wireless receiver 27 may be taken out and used; after it is taken out, the cover body 22 may still be pushed down for normal operation of the wireless mouse with the aid of hook 28.

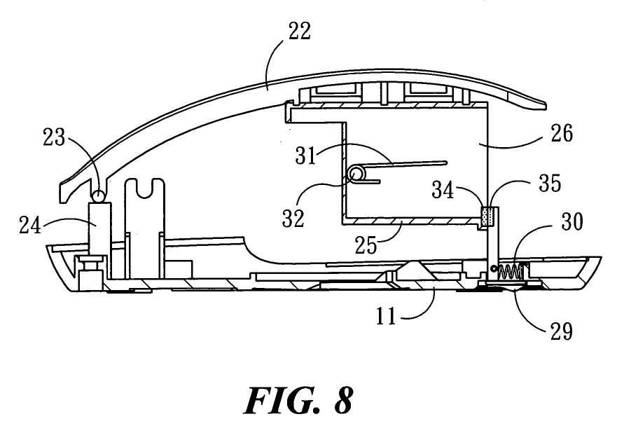

Referring now to FIG. 8, in addition to the aid of hook 28, this invention may also use other measures. For example, a magnet 34 is located below the storage case 25 and relatively a magnet 35 is located at the top side of push button so that the magnets 34 and 35 are arranged with mutually attractive magnetism; when the push button 29 is pushed, the magnet 35 is forced to keep away from the magnet 34 so that the attractive power of magnetism is reduced; thus, the storage case 25 is upward pushed with the tension of spring 31.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A wireless mouse provided with a structure for collecting a wireless receiver, provided with a base inside which a mouse body is located that is masked with a frame outside which a top cover is provided, characterized that:
a lift-suitable cover body is provided in a middle button of the wireless mouse and a storage case is provided below the cover body, inside which an accommodation groove is provided that is used to accommodate the wireless receiver of the wireless mouse.

2. The wireless mouse provided with the structure for collecting the wireless receiver according to claim 1, wherein a shaft is provided at the front end of the cover body, the shaft is located on a pillar stretching from the base upward, and the end of shaft is made to go deep into the frame to be supported.

3. The wireless mouse provided with the structure for collecting the wireless receiver according to claim 1, wherein the storage case is hooked below cover body for removal or replacement of the storage case.

4. The wireless mouse provided with the structure for collecting the wireless receiver according to claim 1, wherein a hook is provided below the storage case, a push button is provided on the base beneath the hook, and a recovery spring is provided between the base and the hook in the direction of compression of the push button, a piercing spring is located on the storage case, and the two ends of spring are fixed onto the frame so that when the push button is compressed, the storage case may be opened upward with the elasticity of spring.

5. The wireless mouse provided with the structure for collecting the wireless receiver according to claim 1, wherein a trigger button is provided at the rear of base, and when the wireless receiver inside the cover body is pushed down, the receiver may push down the trigger button to disable the wireless mouse.

6. The wireless mouse provided with the structure for collecting the wireless receiver according to claim 1, wherein a magnet is located below the storage case and relatively the other magnet is located outside the storage case, a push button is provided on the base stretching from the lower end of the other magnet, the two magnets are arranged with mutually attractive magnetism, a recovery spring is provided between the base and the hook in the direction of compression of the push button, a piercing spring is located on the storage case, and the two ends of spring are fixed onto the frame so that when the push button is compressed, the storage case may be opened upward with the elasticity of spring.
